(19) United States
(12) Patent Application Publication
(10) Pub. No.: US 2024/0176784 A1
(43) Pub. Date: May 30, 2024

(54) ADAPTIVELY GENERATING OUTLIER SCORES USING HISTOGRAMS

(71) Applicant: International Business Machines Corporation, Armonk, NY (US)

(72) Inventors: Yair ALLOUCHE, Dvira (IL); Aviad COHEN, Meitar (IL); Samuel Solomon ACKERMAN, Haifa (IL); Ofer Haim BILLER, Midreshet Ben-Gurion (IL); Eitan Daniel FARCHI, Pardes Hanna-Karkur (IL)

(21) Appl. No.: 18/060,192

(22) Filed: Nov. 30, 2022

(51) Int. Cl. G06F 16/2455; G06F 16/901; G06F 17/18

(52) U.S. Cl. CPC G06F 16/24568; G06F 16/9024; G06F 17/18

(57) ABSTRACT

An example system includes a processor to receive a stream of records. The processor can generate an unbiased outlier score for each sample in the stream of records via a trained histogram-based outlier score model. The unbiased outlier score is unbiased for samples including dependent features using feature grouping. The processor can then detect an anomaly in response to detecting that an associated unbiased outlier score of the sample is higher than a predefined threshold.

### BACKGROUND

The present techniques relate to generating outlier scores. More specifically, the techniques relate to generating outlier scores for objects in data streams.

### SUMMARY

According to an embodiment described herein, a system can include processor to receive a stream of records. The processor can also further generate an unbiased outlier score for each sample in the stream of records via a trained histogram-based outlier score model, wherein the unbiased outlier score is unbiased for samples including dependent features using feature grouping. The processor can also detect an anomaly in response to detecting that an associated unbiased outlier score of the sample is higher than a predefined threshold.

According to another embodiment described herein, a method can include receiving, via a processor, a stream of records. The method can further include inputting, via the processor, samples from the stream of records into a trained histogram-based outlier score model to generate an unbiased outlier score for the samples, wherein the unbiased outlier score is unbiased for samples including dependent features using feature grouping. The method can also further include detecting, via the processor, an anomaly in response to detecting that an unbiased of a sample is higher than a predefined threshold.

According to another embodiment described herein, a computer program product for detecting anomalies in data streams can include computer-readable storage medium having program code embodied therewith. The program code executable by a processor to cause the processor to receive a stream of records. The program code can also cause the processor to. The program code can also cause the processor to generate an unbiased outlier score for each sample in the stream of records via a trained histogram-based outlier score model, wherein the unbiased outlier score is unbiased for samples including dependent features using feature grouping. The program code can also cause the processor to detect an anomaly in response to detecting that an associated unbiased outlier score of the sample is higher than a predefined threshold.

### BRIEF DESCRIPTION OF THE SEVERAL VIEWS OF THE DRAWINGS

FIG. 1 is a block diagram of an example computing environment that contains an example of an environment for the execution of at least some of the computer code involved in performing the inventive methods, such as generating adaptive histogram-based outlier scores;

FIG. 2 is an example tangible, non-transitory computer-readable medium that can adaptively generate outlier scores using histograms;

FIG. 3 is a process flow diagram of an example method that can train a histogram-based outlier score model;

FIG. 4 is a process flow diagram of an example method that can generate outlier scores for grouped interdependent features;

FIG. 5 is a process flow diagram of an example method that can normalize outlier scores by numbers of features and define default histograms to be used for new features;

FIG. 6 is a process flow diagram of an example method that can merge histogram models using bins;

FIG. 7 is a block diagram of an example system for adaptively generating outlier scores using histograms;

FIG. 8 is a flow chart of an example process for the generation of a combined histogram for adaptively updating a histogram-based outlier score model;

FIG. 9 is a cluster graph of an example grouping of interdependent features; and

FIG. 10 is a graph of the probabilities of a value of a feature over time after consecutive merging processes for a number of different alpha values.

### DETAILED DESCRIPTION

Anomaly detection, also known as outlier detection, is a discipline in machine learning aimed at detecting anomalies in given labeled or unlabeled data. Histogram-based outlier score (HBOS), first released by Goldstein et. al in 2012, is an unsupervised anomaly detection algorithm that scores records in linear time. For each feature in a multivariate data, HBOS builds a normalized histogram (max=1.0) with predefined bins. The formula of HBOS is as follows:

$$HBOS ( v ) = {\sum }_{i = 0}^{d} log ( \frac{1}{{hist}_{i} ( v )} ) \qquad Eq . 1$$

where d is a fixed feature dimension, v is a value from the record being scored, and histᵢ(v) returns the score for value v from the histogram that represent feature i in the model. The HBOS algorithm outputs a histogram-based outlier score for each sample in a data stream, which can be used to detect anomalies in the data stream. For example, the score provided for each sample may be the difference between the sample and some baseline. In particular, the amount of information for reach feature is calculated independently and summed together along a dimension to determine an amount of information available in the specific sample. As one example, a form communication may be streaming with different attributes, which may be treated features. For example, the features may include the source of the communication, what protocols are being used, the number of packets sent from the source to the destination, the number of packets sent from the destination to the source. For each feature, the amount of information within the data may be calculated. For example, the amount of information received with respect to a feature may correspond to the rarity or low probability of the received information. The values of the features of the communication may be summed together in order to determine the rarity of the communication itself. A communication that is rarer would thus receive a higher anomaly score, indicating a larger distance between the communication and a baseline for communications. An anomaly may be detected by comparing the anomaly scores among a number of communications and detecting communication that has an anomaly score that is higher than other communications. As one example, a system may have many thousands or millions of such communications per hour. HBOS may perform well on global anomaly detection problems and much faster than standard algorithms, especially on large data sets. However, the HBOS algorithm has several drawbacks. First, as can be seen from Eq. 1, HBOS assumes a fixed feature dimension d, and therefore expects to receive same-size feature vector when trained or applied. For example, if the model was trained on 20 features, then the model may accordingly expect to receive 20 features at test time. Hence, HBOS cannot cope with instances that do not have exactly the same features over time. Thus, HBOS may not support a dynamic feature space. Moreover, the trivial solution of summing only available features may result in highly biased score. In particular, entities with higher dimensions may produce a total higher anomaly score in comparison to entities with lower dimensions. In addition, the HBOS score is a multiplication of the inverse of the estimated densities that assumes independence of the features. However, in many cases, the features may be interdependent, and this interdependence may cause a bias since when an observation has an irregularity, abnormality, or anomaly in one feature, the anomality will probably be found also in other features that are dependent with the first feature. Thus, an irregularity in a dependent feature may produce a total higher anomaly score in comparison to the same irregularity in an independent feature. Finally, HBOS does not support model updates. For example, when the model needs to be updated, the model is just trained again with new larger dataset. Such retraining may be inefficient.

According to embodiments of the present disclosure, a system includes a processor that can receive a stream of records. The processor can generate an unbiased outlier score for each sample in the stream of records via a trained histogram-based outlier score model. The unbiased outlier score is unbiased for samples including dependent features using feature grouping. The processor can then detect an anomaly in response to detecting that an associated unbiased outlier score of the sample is higher than a predefined threshold. As one example, the predefined threshold may be based on unbiased outlier scores of other samples. Thus, embodiments of the present disclosure enable anomaly detection algorithms that assume feature independency also on datasets that have dependent features to some degree, while neutralizing the bias effect of dependent features. Thus, the embodiments can produce unbiased outlier scores for instances with dependent features. Furthermore, the embodiments provide the ability to update a model with new instances, regularly, without the need to keep the previous training set. The outlier models generated by the embodiments can be updated with new data continuously in an adaptive manner, which is appropriate to be utilized in solutions run in production on stream data. In addition, the embodiments enable setting a weight for each update, and controlling, with a single hyper-parameter, the balance between the weight of the new update and the weight of total updates up to that point in time. The embodiments described herein can thus cope with varying feature dimensions while producing unbiased outlier scores for that case. For example, features can be added or removed over time.

Various aspects of the present disclosure are described by narrative text, flowcharts, block diagrams of computer systems and/or block diagrams of the machine logic included in computer program product (CPP) embodiments. With respect to any flowcharts, depending upon the technology involved, the operations can be performed in a different order than what is shown in a given flowchart. For example, again depending upon the technology involved, two operations shown in successive flowchart blocks may be performed in reverse order, as a single integrated step, concurrently, or in a manner at least partially overlapping in time.

A computer program product embodiment (“CPP embodiment” or “CPP”) is a term used in the present disclosure to describe any set of one, or more, storage media (also called “mediums”) collectively included in a set of one, or more, storage devices that collectively include machine readable code corresponding to instructions and/or data for performing computer operations specified in a given CPP claim. A “storage device” is any tangible device that can retain and store instructions for use by a computer processor. Without limitation, the computer readable storage medium may be an electronic storage medium, a magnetic storage medium, an optical storage medium, an electromagnetic storage medium, a semiconductor storage medium, a mechanical storage medium, or any suitable combination of the foregoing. Some known types of storage devices that include these mediums include: diskette, hard disk, random access memory (RAM), read-only memory (ROM), erasable programmable read-only memory (EPROM or Flash memory), static random access memory (SRAM), compact disc read-only memory (CD-ROM), digital versatile disk (DVD), memory stick, floppy disk, mechanically encoded device (such as punch cards or pits/lands formed in a major surface of a disc) or any suitable combination of the foregoing. A computer readable storage medium, as that term is used in the present disclosure, is not to be construed as storage in the form of transitory signals per se, such as radio waves or other freely propagating electromagnetic waves, electromagnetic waves propagating through a waveguide, light pulses passing through a fiber optic cable, electrical signals communicated through a wire, and/or other transmission media. As will be understood by those of skill in the art, data is typically moved at some occasional points in time during normal operations of a storage device, such as during access, de-fragmentation or garbage collection, but this does not render the storage device as transitory because the data is not transitory while it is stored.

Computing environment 100 contains an example of an environment for the execution of at least some of the computer code involved in performing the inventive methods, such as an adaptive histogram-based outlier score module 200. In addition to block 200, computing environment 100 includes, for example, computer 101, wide area network (WAN) 102, end user device (EUD) 103, remote server 104, public cloud 105, and private cloud 106. In this embodiment, computer 101 includes processor set 110 (including processing circuitry 120 and cache 121), communication fabric 111, volatile memory 112, persistent storage 113 (including operating system 122 and block 200, as identified above), peripheral device set 114 (including user interface (UI), device set 123, storage 124, and Internet of Things (IoT) sensor set 125), and network module 115. Remote server 104 includes remote database 130. Public cloud 105 includes gateway 140, cloud orchestration module 141, host physical machine set 142, virtual machine set 143, and container set 144.

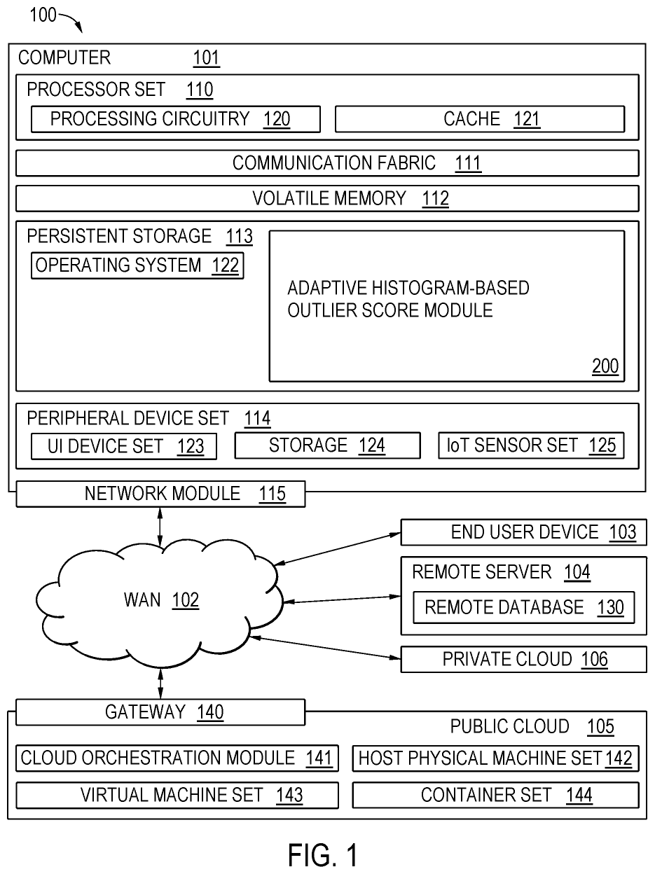

COMPUTER 101 may take the form of a desktop computer, laptop computer, tablet computer, smart phone, smart watch or other wearable computer, mainframe computer, quantum computer or any other form of computer or mobile device now known or to be developed in the future that is capable of running a program, accessing a network or querying a database, such as remote database 130. As is well understood in the art of computer technology, and depending upon the technology, performance of a computer-implemented method may be distributed among multiple computers and/or between multiple locations. On the other hand, in this presentation of computing environment 100, detailed discussion is focused on a single computer, specifically computer 101, to keep the presentation as simple as possible. Computer 101 may be located in a cloud, even though it is not shown in a cloud in FIG. 1. On the other hand, computer 101 is not required to be in a cloud except to any extent as may be affirmatively indicated.

PROCESSOR SET 110 includes one, or more, computer processors of any type now known or to be developed in the future. Processing circuitry 120 may be distributed over multiple packages, for example, multiple, coordinated integrated circuit chips. Processing circuitry 120 may implement multiple processor threads and/or multiple processor cores. Cache 121 is memory that is located in the processor chip package(s) and is typically used for data or code that should be available for rapid access by the threads or cores running on processor set 110. Cache memories are typically organized into multiple levels depending upon relative proximity to the processing circuitry. Alternatively, some, or all, of the cache for the processor set may be located “off chip.” In some computing environments, processor set 110 may be designed for working with qubits and performing quantum computing.

Computer readable program instructions are typically loaded onto computer 101 to cause a series of operational steps to be performed by processor set 110 of computer 101 and thereby effect a computer-implemented method, such that the instructions thus executed will instantiate the methods specified in flowcharts and/or narrative descriptions of computer-implemented methods included in this document (collectively referred to as “the inventive methods”). These computer readable program instructions are stored in various types of computer readable storage media, such as cache 121 and the other storage media discussed below. The program instructions, and associated data, are accessed by processor set 110 to control and direct performance of the inventive methods. In computing environment 100, at least some of the instructions for performing the inventive methods may be stored in block 200 in persistent storage 113.

COMMUNICATION FABRIC 111 is the signal conduction paths that allow the various components of computer 101 to communicate with each other. Typically, this fabric is made of switches and electrically conductive paths, such as the switches and electrically conductive paths that make up busses, bridges, physical input/output ports and the like. Other types of signal communication paths may be used, such as fiber optic communication paths and/or wireless communication paths.

VOLATILE MEMORY 112 is any type of volatile memory now known or to be developed in the future. Examples include dynamic type random access memory (RAM) or static type RAM. Typically, the volatile memory is characterized by random access, but this is not required unless affirmatively indicated. In computer 101, the volatile memory 112 is located in a single package and is internal to computer 101, but, alternatively or additionally, the volatile memory may be distributed over multiple packages and/or located externally with respect to computer 101.

PERSISTENT STORAGE 113 is any form of non-volatile storage for computers that is now known or to be developed in the future. The non-volatility of this storage means that the stored data is maintained regardless of whether power is being supplied to computer 101 and/or directly to persistent storage 113. Persistent storage 113 may be a read only memory (ROM), but typically at least a portion of the persistent storage allows writing of data, deletion of data and re-writing of data. Some familiar forms of persistent storage include magnetic disks and solid state storage devices. Operating system 122 may take several forms, such as various known proprietary operating systems or open source Portable Operating System Interface type operating systems that employ a kernel. The code included in block 200 typically includes at least some of the computer code involved in performing the inventive methods.

PERIPHERAL DEVICE SET 114 includes the set of peripheral devices of computer 101. Data communication connections between the peripheral devices and the other components of computer 101 may be implemented in various ways, such as Bluetooth connections, Near-Field Communication (NFC) connections, connections made by cables (such as universal serial bus (USB) type cables), insertion type connections (for example, secure digital (SD) card), connections made through local area communication networks and even connections made through wide area networks such as the internet. In various embodiments, UI device set 123 may include components such as a display screen, speaker, microphone, wearable devices (such as goggles and smart watches), keyboard, mouse, printer, touchpad, game controllers, and haptic devices. Storage 124 is external storage, such as an external hard drive, or insertable storage, such as an SD card. Storage 124 may be persistent and/or volatile. In some embodiments, storage 124 may take the form of a quantum computing storage device for storing data in the form of qubits. In embodiments where computer 101 is required to have a large amount of storage (for example, where computer 101 locally stores and manages a large database) then this storage may be provided by peripheral storage devices designed for storing very large amounts of data, such as a storage area network (SAN) that is shared by multiple, geographically distributed computers. IoT sensor set 125 is made up of sensors that can be used in Internet of Things applications. For example, one sensor may be a thermometer and another sensor may be a motion detector.

NETWORK MODULE 115 is the collection of computer software, hardware, and firmware that allows computer 101 to communicate with other computers through WAN 102. Network module 115 may include hardware, such as modems or Wi-Fi signal transceivers, software for packetizing and/or de-packetizing data for communication network transmission, and/or web browser software for communicating data over the internet. In some embodiments, network control functions and network forwarding functions of network module 115 are performed on the same physical hardware device. In other embodiments (for example, embodiments that utilize software-defined networking (SDN)), the control functions and the forwarding functions of network module 115 are performed on physically separate devices, such that the control functions manage several different network hardware devices. Computer readable program instructions for performing the inventive methods can typically be downloaded to computer 101 from an external computer or external storage device through a network adapter card or network interface included in network module 115.

WAN 102 is any wide area network (for example, the internet) capable of communicating computer data over non-local distances by any technology for communicating computer data, now known or to be developed in the future. In some embodiments, the WAN may be replaced and/or supplemented by local area networks (LANs) designed to communicate data between devices located in a local area, such as a Wi-Fi network. The WAN and/or LANs typically include computer hardware such as copper transmission cables, optical transmission fibers, wireless transmission, routers, firewalls, switches, gateway computers and edge servers.

END USER DEVICE (EUD) 103 is any computer system that is used and controlled by an end user (for example, a customer of an enterprise that operates computer 101), and may take any of the forms discussed above in connection with computer 101. EUD 103 typically receives helpful and useful data from the operations of computer 101. For example, in a hypothetical case where computer 101 is designed to provide a recommendation to an end user, this recommendation would typically be communicated from network module 115 of computer 101 through WAN 102 to EUD 103. In this way, EUD 103 can display, or otherwise present, the recommendation to an end user. In some embodiments, EUD 103 may be a client device, such as thin client, heavy client, mainframe computer, desktop computer and so on.

REMOTE SERVER 104 is any computer system that serves at least some data and/or functionality to computer 101. Remote server 104 may be controlled and used by the same entity that operates computer 101. Remote server 104 represents the machine(s) that collect and store helpful and useful data for use by other computers, such as computer 101. For example, in a hypothetical case where computer 101 is designed and programmed to provide a recommendation based on historical data, then this historical data may be provided to computer 101 from remote database 130 of remote server 104.

PUBLIC CLOUD 105 is any computer system available for use by multiple entities that provides on-demand availability of computer system resources and/or other computer capabilities, especially data storage (cloud storage) and computing power, without direct active management by the user. Cloud computing typically leverages sharing of resources to achieve coherence and economies of scale. The direct and active management of the computing resources of public cloud 105 is performed by the computer hardware and/or software of cloud orchestration module 141. The computing resources provided by public cloud 105 are typically implemented by virtual computing environments that run on various computers making up the computers of host physical machine set 142, which is the universe of physical computers in and/or available to public cloud 105. The virtual computing environments (VCEs) typically take the form of virtual machines from virtual machine set 143 and/or containers from container set 144. It is understood that these VCEs may be stored as images and may be transferred among and between the various physical machine hosts, either as images or after instantiation of the VCE. Cloud orchestration module 141 manages the transfer and storage of images, deploys new instantiations of VCEs and manages active instantiations of VCE deployments. Gateway 140 is the collection of computer software, hardware, and firmware that allows public cloud 105 to communicate through WAN 102.

Some further explanation of virtualized computing environments (VCEs) will now be provided. VCEs can be stored as “images.” A new active instance of the VCE can be instantiated from the image. Two familiar types of VCEs are virtual machines and containers. A container is a VCE that uses operating-system-level virtualization. This refers to an operating system feature in which the kernel allows the existence of multiple isolated user-space instances, called containers. These isolated user-space instances typically behave as real computers from the point of view of programs running in them. A computer program running on an ordinary operating system can utilize all resources of that computer, such as connected devices, files and folders, network shares, CPU power, and quantifiable hardware capabilities. However, programs running inside a container can only use the contents of the container and devices assigned to the container, a feature which is known as containerization.

PRIVATE CLOUD 106 is similar to public cloud 105, except that the computing resources are only available for use by a single enterprise. While private cloud 106 is depicted as being in communication with WAN 102, in other embodiments a private cloud may be disconnected from the internet entirely and only accessible through a local/private network. A hybrid cloud is a composition of multiple clouds of different types (for example, private, community or public cloud types), often respectively implemented by different vendors. Each of the multiple clouds remains a separate and discrete entity, but the larger hybrid cloud architecture is bound together by standardized or proprietary technology that enables orchestration, management, and/or data/application portability between the multiple constituent clouds. In this embodiment, public cloud 105 and private cloud 106 are both part of a larger hybrid cloud.

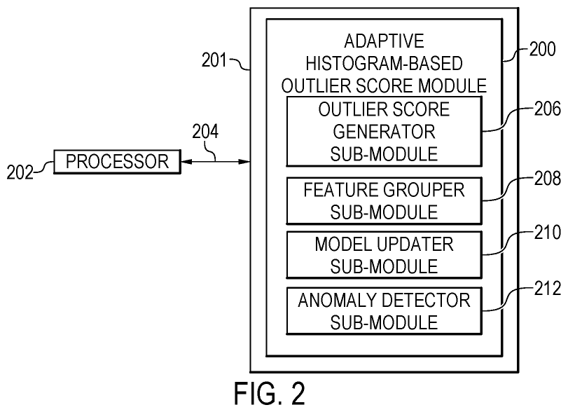

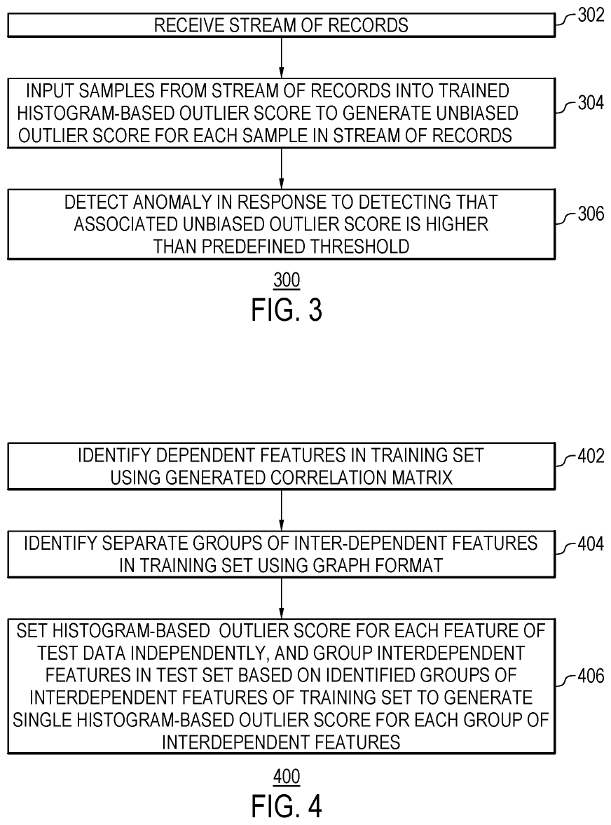

Referring now to FIG. 2, a block diagram is depicted of an example tangible, non-transitory computer-readable medium 201 that can adaptively generate outlier scores using histograms. The tangible, non-transitory, computer-readable medium 201 may be accessed by a processor 202 over a computer interconnect 204. Furthermore, the tangible, non-transitory, computer-readable medium 201 may include code to direct the processor 202 to perform the operations of the methods 300-600 of FIGS. 3-6.

The various software components discussed herein may be stored on the tangible, non-transitory, computer-readable medium 201, as indicated in FIG. 2. For example, the adaptive histogram-based outlier score module 200 includes an outlier score generator sub-module 206 that includes code to receive a stream of records. In some examples, the outlier score generator module 206 includes code to generate an unbiased outlier score for each sample in the stream of records via a trained histogram-based outlier score model. In various examples, the outlier score generator module 206 includes code to normalize the unbiased outlier score based on the number of feature dimensions of each sample. A feature grouper module 208 includes code to remove bias for samples including dependent features using feature grouping. For example, the feature grouper module 208 may include code to identify dependent features in a training set using a generated correlation matrix. The feature grouper module 208 further includes code to identify separate groups of interdependent features in the training set using a graph format. The feature grouper module 208 also includes code to set a histogram-based outlier score for each feature of the stream of records independently, and group interdependent features in the stream of records based on identified groups of interdependent features of the training set to generate a single histogram-based outlier score for each group of interdependent features. A module updater module 210 includes code to adaptively update the trained histogram-based outlier score model based on the stream of records. For example, the model updater module 210 may include code to receive the trained histogram-based outlier score model including a histogram with bins fitted with an initial training set. The module updater module 210 may also include code to generate an update histogram with the same bins based on new data from the stream of records. The model updater sub-module 210 may also include code to merge the histogram of the model with the updated histogram to generate a merged histogram for an updated model. An anomaly detector sub-module 212 includes code to detect an anomaly in response to detecting that an associated unbiased outlier score of the sample is higher than a predefined threshold.

FIG. 3 is a process flow diagram of an example method that can train a histogram-based outlier score model. The method 300 can be implemented with any suitable computing device, such as the computer 101 of FIG. 1. For example, the methods described below can be implemented by the processor set 110 of FIG. 1.

At block 302, a processor receives a stream of records. For example, the stream of records may have a number of samples to be assigned with outlier scores. As one example, the stream of records may be records of a communication system.

At block 304, the processor inputs samples from the stream of records into a trained histogram-based outlier score model to generate an unbiased outlier score for the samples. For example, the unbiased outlier score is unbiased for samples including dependent features using feature grouping. As one example, the outlier score may be unbiased for dependent features using the feature grouping of the method 400 of FIG. 4. In various examples, the unbiased outlier score is normalized based on a number of feature dimensions of each sample.

At block 306, the processor detects an anomaly in response to detecting that an unbiased of a sample is higher than a predefined threshold. In some examples, the processor detects an anomaly in response to detecting that an unbiased of a sample is higher than unbiased outlier scores of other samples. As one example, the anomaly may correspond to a potential intrusion of an unauthorized user in a communication system.

The process flow diagram of FIG. 3 is not intended to indicate that the operations of the method 300 are to be executed in any particular order, or that all of the operations of the method 300 are to be included in every case. Additionally, the method 300 can include any suitable number of additional operations.

FIG. 4 is a process flow diagram of an example method that can generate outlier scores for grouped interdependent features. The method 400 can be implemented with any suitable computing device, such as the computer 101 of FIG. 1. For example, the methods described below can be implemented by the processor set 110 of FIG. 1.

At block 402, a processor identifies dependent features in a training set using a generated correlation matrix. For example, the correlation matrix may include a calculated correlation between each possible pair of features in the training set. In some examples, the

At block 404, the processor identifies separate groups of interdependent features in the training set using a graph format. For example, each feature in the graph format may be represented as a vertex, and correlations may be represented in the graph format by edges between the vertices. In various examples, the edges may have weights corresponding to a correlation degree between two vertices connected by the edge.

At block 406, the processor sets a histogram-based outlier score for each feature of the stream of records independently, and groups interdependent features in the stream of records based on identified groups of interdependent features of the training set to generate a single histogram-based outlier score for each group of interdependent features.

The process flow diagram of FIG. 4 is not intended to indicate that the operations of the method 400 are to be executed in any particular order, or that all of the operations of the method 400 are to be included in every case. Additionally, the method 400 can include any suitable number of additional operations.

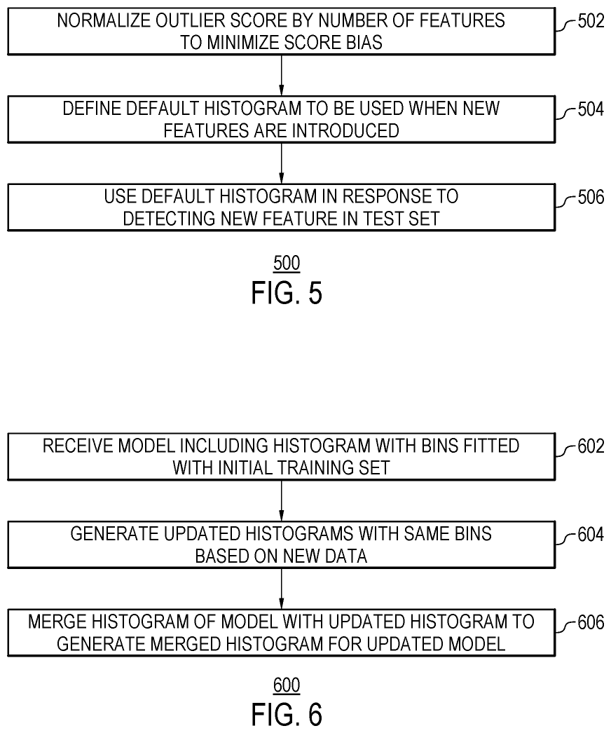

FIG. 5 is a process flow diagram of an example method that can normalize outlier scores by numbers of features and define default histograms to be used for new features. The method 500 can be implemented with any suitable computing device, such as the computer 101 of FIG. 1. For example, the methods described below can be implemented by the processor set 110 of FIG. 1.

At block 502, a processor normalizes an outlier score by a number of features to minimize score bias. For example, the outlier score for a particular sample may be normalized by the number of features found in the particular sample.

At block 504, the processor defines a default histogram to be used when new features are introduced. For example, the predefined histogram may indicate a probability of 0:{2∧(−10)}. In some examples, the processor can also define a default histogram to be used when a feature was seen in the training set and thus has an associated histogram model but does not appear in the test set. For example, the default predefined histogram used may be {0:2∧(−8)}, which represents a very low probability that result in high anomaly score for the feature.

At block 506, the processor uses the default histogram in response to detecting a new feature in the test set. The test set may be a stream of records. For example, the processor can use a default predefined histogram that represents a very low probability that results in a high anomaly score for the feature in response to detecting that a new feature is encountered in the test set and is not present in the training set. Alternatively, the processor can optionally use another default predefined histogram for the feature instead of the feature histogram of the training set in response to detecting that a feature was in the training set but is not in the test set.

The process flow diagram of FIG. 5 is not intended to indicate that the operations of the method 500 are to be executed in any particular order, or that all of the operations of the method 500 are to be included in every case. Additionally, the method 500 can include any suitable number of additional operations.

FIG. 6 is a process flow diagram of an example method that can merge histogram models using bins. The method 600 can be implemented with any suitable computing device, such as the computer 101 of FIG. 1. For example, the methods described below can be implemented by the processor set 110 of FIG. 1.

At block 602, a processor receives a model including a histogram with bins fitted with an initial training set. For example, the model may be a trained histogram-based outlier score model.

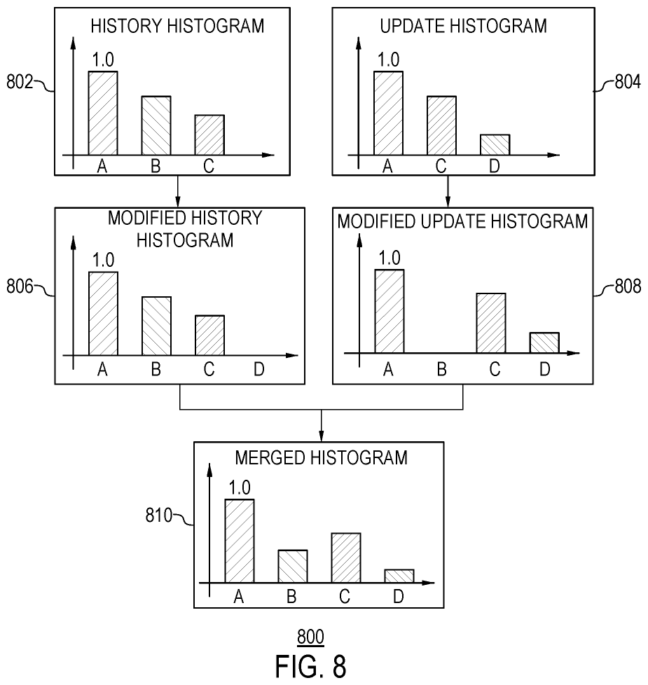

At block 604, the processor generates updated histograms with the same bins based on new data from the stream of records. For example, an updated histogram may be generated for both a history histogram and an update histogram, as shown in the example of FIG. 8.

At block 606, the processor merges the updated histograms to generate a merged histogram for an updated model. For example, each of the corresponding bins between the two updated histograms may be merged into a new value based on a given alpha hyper-parameter that indicates a relative weight to give to historical versus new values.

The process flow diagram of FIG. 6 is not intended to indicate that the operations of the method 600 are to be executed in any particular order, or that all of the operations of the method 600 are to be included in every case. Additionally, the method 600 can include any suitable number of additional operations.

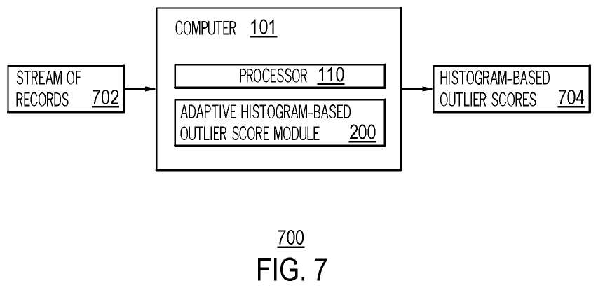

With reference now to FIG. 7, a block diagram shows an example system for adaptively generating outlier scores using histograms. The example system is generally referred to by the reference number 700. FIG. 7 includes similarly referenced elements from FIG. 1. In addition, the computer 101 of system 700 is shown receiving a stream of records 702 and generating histogram-based outlier scores 704.

In the example of FIG. 7, the processor can adapt a model to unfixed features that change over time. In some examples, the processor can use an HBOS formula with a modification to minimize score bias. For example, the processor can normalize the outlier score by the number of dimensions to cope with varying feature dimensions using the following RA-HBOS formula:

$$RA - HBOS ( v ) = \frac{1}{d} {\sum }_{i = 0}^{d} log ( \frac{1}{{hist}_{i} ( v )} ) \qquad Eq . 2$$

where v is a feature vector, and d are the number of dimensions/features of the given sample. Due to the score normalization, outlier scores of instances with different features can be compared.

Still referring to FIG. 7, like the regular HBOS model based on Eq. 1 above, when trained, the RA-HBOS formula builds a model that includes a normalized histogram for each feature in the training set. Each histogram contains the values of the features (indicated on the X-axis) and the probability of the value (indicated on the Y-axis). The probabilities are normalized by the maximal probability so that the most probable value gets a probability of 1.0.

When the RA-HBOS model is applied on a test set, the RA-HBOS model leverages changes in the test set features in comparison to the train set features, to better detect anomalies. For example, when a new feature is encountered in the test set and is not present in the training set (an anomaly), the new feature does not have an existing histogram model. In this case, the RA-HBOS algorithm can use a default predefined histogram that represents a very low probability that results in a high anomaly score for the feature. For example, the predefined histogram may indicate a probability of 0:{2⁻¹⁰}. Alternatively, if a feature was seen in the training set and thus has an associated histogram model but does not appear in the test set and is thus detected as an anomaly, then the algorithm can optionally use another default predefined histogram for the feature instead of the feature histogram of the training set. For example, the default predefined histogram used may be {0:2⁻⁸}, which represents a very low probability that result in high anomaly score for the feature.

In various examples, the processor can also adapt the model to cope with dependent features. For example, to cope with dependent features and the bias that it may cause in anomaly detection, the processor can first group the features according to their inter-correlation. Then, the processor calculates the anomaly score when taking into consideration the features groups. In various examples, the processor may implement feature grouping by first identifying dependent (correlated) features in the training set. For example, there may be several groups of inter-dependent features. To do so, the processor can produce a correlation matrix using some correlation method. For example, the correlation method may be the Pearson method, Spearman method, Kendall method, etc. The correlation matrix holds the correlation coefficient between each pair of features in the dataset. In some examples, each correlation coefficient may be a value between −1≤x≤1. The processor 110 may consider two features as dependent when their absolute coefficient is greater than a predefined threshold. For example, the threshold may be 0.8. In various examples, redundant features may have a correlation coefficient of 1.

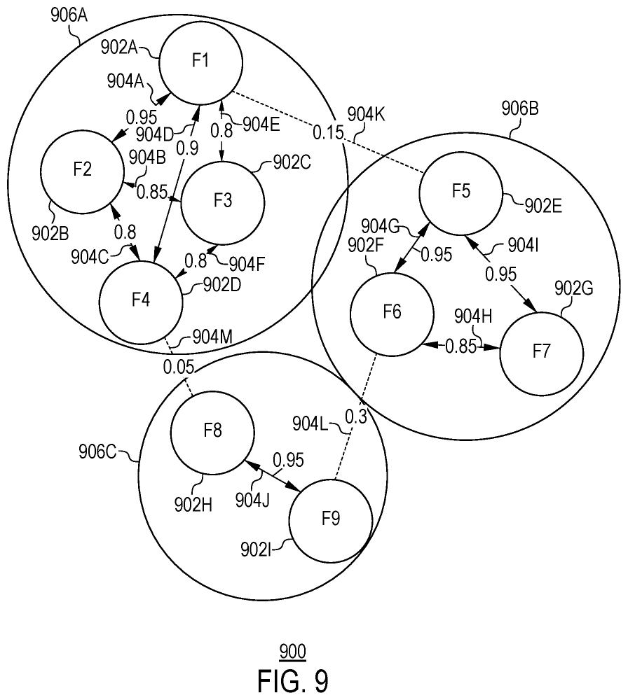

The processor may then identify separate groups of inter-dependent features. A group can contain one or more inter-dependent features. To do so, the processor may first model the feature correlation in a graph format in which each feature is a vertex, and a correlation between two features is represented by an edge with a weight that corresponds to the correlation degree. For example, the weight may be in the form of a correlation coefficient between the two features. Then, using this graph, the processor can model the problem as a graph clustering problem or clique problem in graph theory. A solution finds sets of related vertices represented by clusters or communities in the graph. In various examples, the processor can solve the problem by applying a graph clustering algorithm. For example, the graph clustering algorithm may be the Markov Clustering algorithm, Iterative Conductance Cutting (ICC) algorithm, Geometric MST Clustering (GMC) algorithm. In some examples, the processor can additionally or alternatively solve the problem by applying a community detection algorithm to the graph. For example, the community detection algorithm may be the Girvan-Newman algorithm, Louvain algorithm, Surprise algorithm, Leiden, Walktrap algorithm, etc. An example graph with identified interdependent groups is shown in FIG. 9.

In various examples, the processor can generate group-based HBOS scores based on the identified interdependent groups of features. For example, when the RA-HBOS model is applied to new data, as during prediction, the processor may set an anomaly score for each feature independently. If groups of interdependent features are found in training set, then the RA-HBOS model may treat every group of features as a single feature when calculating the total anomaly score for an instance. For example, the processor may do so by using an appropriate predefined function that is applied to the anomaly scores of the features and convert them to a single anomaly score. In various examples, the function may be a max function, mean function, etc. As one example, if a group of inter-dependent features contains three features with anomaly scores of 0.0, 3.5, 12.0, then the RA-HBOS may treat the three features as a single feature with an anomaly score of max(0.0, 3.5, 12.0)=12. Because all the interdependent features in a group are represented as a single feature, the dependency between them is neglected when calculating the total anomaly score of an instance, and the bias may thus be neutralized.

In various examples, the processor can also update the RA-HBOS model to make the model adaptive to new data points. For example, the processor can fit the RA-HBOS model with an initial training set and then update the model with a new dataset as many times as needed. In some examples, the RA-HBOS model may support different weights for each fit and update, and enable controlling the balance between the weight of the new update data and the weight of the current model, with a single hyper-parameter. In various examples, the processor may start the update process of RA-HBOS model by first generating a histogram for new data with same bins as the histogram for the previous model and then merging the two histograms. On each update, for each feature, the RA-HBOS algorithm merges the histogram of the current model (i.e., history) with the histogram of the new update. If a feature does not exist in current model or in the new update, then the processor may use an empty histogram that reflects a probability of no values. For example, the histogram may be 0:1.0, N/A:1.0, depending on the domain. In various examples, the definition of the empty histogram may depends on the domain. For example, there may be domains in which an empty histogram represents a value of 0 with score of 1.0, such as network domains. In other domains, no value is actually a None (N/A) with score of 1.0.

As one specific example, the following example algorithms may be used as part of the RA-HBOS algorithm:

```
Model Global Variables:
  1.  model = { }
  2.  fit_plus_updates_num = 0
  3.  total_weights = 0
Model Train:
Input:
  (1) training_set
  (2) weight
              Algorithm 1:
    IDFG = Find_IDFG(training_set, feature_correlation_method)
    For feature in features of training_set:
    model[feature] = Build_Histogram(training_set, feature, histogram_bins)
    fit_plus_updates_num = 1
    total_weights += weight
Model Test:
Input:
  (1) test_set
              Algorithm 2:
  1.  if consider_features_in_train_not_found_in_test:
    Add_Missing_Features_To_Dataset(dataset=test_set,
    features=model.keys,
    value=0)
  2.  instances_anomaly_scores = [ ]
  3.  for instance in test_set:
    Instance_feature_scores = { }
    For feature in instance:
          i. Probability = prob_feature_not_found
          ii. If feature in model:
            1.  probability = Get_Prob(histogram=model[feature],
            2.  value=instance[feature])
          iii. score = Get_Score(probability)
          iv. Instance_feature_scores[feature] = score
    feature_correlation_group_funcInstance_feature_scores =
      Merge_Dependent_Features(IDFG,
    feature_correlation_group_funcinstance_feature_scores,
    feature_correlation_group_funcfunction=)
    instances_anomaly_scores.append(
      features_score_function(Instance_feature_scores. values( )))
  4.  total_weights += weight
  5.  return instances_anomaly_scores
Model Update
Input:
  (1) update_set
  (2) update_weight
              Algorithm 3:
  1. for feature in set(update_set.features,model.keys):
    a. old_hist = model[feature] # if not exist return None
    b. new_hist = Build_Histogram(update_set, feature, histogram_bins)
    c. updated_hist = Merge_Histograms(old_hist,new_hist,update_weight)
    d. model[feature] = updated_hist
  2. fit_plus_updates_num += 1
total_weights += update_weight
```

where the inputs include a histogram_bins input that represents the number of bins to use when building a histogram. The normalization_factor input represents the factor multiplied with the maximal probability before normalizing the histogram of a feature. For example, the default value=1.0 (no affect). The prob_value_not_found input represents the probability to set when a value not found in the feature's histogram. The prob_feature_not_found input represents the probability to set when feature in the test set not found in the model built using the training set. The consider_features_in_train_not_found_in_test input indicates whether or not consider features found in training set but does not appear in the test set. The features_score_function input indicates the function to apply on the scores of features. For example, the function may be a sum, mean, max, generalized mean, etc. The feature_correlation_method input indicates the method used to calculate the correlation between the features. For example, the method may be the Pearson, Spearman, Kendall, among other suitable methods. The feature_correlation_threshold input indicates the threshold above which two features are considered correlated. The feature_correlation_group_func input indicates the function to apply to anomaly scores from features from the same group. The model_update_a indicates the alpha used when updating the model. In addition, the functions of the algorithms include a Build_Histogram(dataset, feature, bins) function that builds a normalized histogram for a feature in a dataset. The functions include a Get_Prob(histogram, value) function that returns the probability of a value from a given histogram. If the value is not found in the given histogram, then this function returns prob_value_not_found. The functions include a Get_Outlier_Score(probability) function that calculates the anomaly score of given probability. For example, the anomaly score may be calculated using Eq. 2. The functions include a Merge_Histograms(old_hist, new_hist, new_hist_weight) function that merges two given histograms, old and new, to one merged histogram, as explained in Algorithm 3, and using the ‘Merge_Probabilities’ function. The Merge_Probabilities(old_prob,new_prob,history_weight,update_weight,alpha) function merges two probabilities according to Eq. 3 described below. The Find_IDFG(dataset,method) function finds inter-dependent feature groups (IDFGs) from a given dataset using given method. The Add_Missing_Features_To_Dataset(dataset, features, value) function adds the given features to dataset with given value. Finally, the Merge_Dependent_Features(IDFG,features_scores,function) function merges, using a given function, the score of features according to groups in IDFG.

As another example, a processor can receive a stream of records. The processor can generate an unbiased outlier score for each sample in the stream of records via a trained histogram-based outlier score model, wherein the unbiased outlier score is normalized based on a number of feature dimensions of each sample. The processor can then detect an anomaly in response to detecting that an associated unbiased outlier score of the sample is higher than a predefined threshold. In some examples, the processor can detect an anomaly in response to detecting that an associated unbiased outlier score of the sample is higher than unbiased outlier scores of other samples. In some examples, the unbiased outlier score is unbiased for samples including dependent features. In some examples, the processor can use a defined default histogram in response to detecting that a sample in the stream of records includes a new feature. In some examples, the processor can train the histogram-based outlier score model with feature grouping, wherein the unbiased outlier score includes a group-based outlier score. In various examples, the processor can continuously and adaptively update an outlier score model based on new data received from the stream of records. In some examples, the processor can update the trained histogram-based outlier score model using a histogram merging. In some examples, the processor can receive a hyper-parameter, and update the trained histogram-based outlier score model by setting a balance between the weight of a new update and a weight of a previous value of a feature in an outlier score model based on the received hyper-parameter.

It is to be understood that the block diagram of FIG. 7 is not intended to indicate that the system 700 is to include all of the components shown in FIG. 7. Rather, the system 700 can include fewer or additional components not illustrated in FIG. 7 (e.g., additional client devices, or additional streams of records, histogram-based outlier scores, etc.).

FIG. 8 is a flow chart of an example process for the generation of a combined histogram for adaptively updating a histogram-based outlier score model. The example merging process 800 of FIG. 8 includes a history histogram 802 representing historical values A, B, and C. The merging process 800 includes an update histogram with updated values A, C, and D. The merging process 800 includes a modified history histogram 806 representing historical values A, B, and C and a placeholder for value D. The merging process 800 includes a modified update histogram 808 with updated values A, C, and D, and a placeholder for value B. The merging process 800 also further includes a merged histogram 810, which is a combination of the values A, B, C, and D in the modified history histogram 806 and the modified update histogram 808.

FIG. 8 provides a simple example of merging two histograms of the values of the same feature. The history histogram 802 on the left represents the history, and the update histogram 804 on the right represents a new update. In the example of FIG. 8, the history histogram 802 lacks the value ‘D’ and the update histogram 804 lacks the value ‘B’. In various examples, a processor may first bring the two histograms 702 and 704 to a common ground, in which both modified histograms 706 and 708 have all the values from the history and the update. As seen in FIG. 8, each of the history histogram 706 and the updated histogram 708 include the values A, B, C and D. The processor can then secondly merge the two histograms 706 and 708 to one merged histogram 710. In various examples, the processor can merge the histograms 706 and 708 using the above Equation 3. For example, the processor can apply Eq. 3 below for each value in the common ground of the two histograms.

In various examples, a processor may apply more weight on new samples over old samples in order to get up-to-date histograms for features. In this regard, the processor may more specifically use the RA-HBOS hyper-parameter alpha (α) used to balance the history weight versus the new sample weight. In some examples, the merging process 800 may take into account the total weight of the history W_{H}, which is the sum of weights of the first fit and all the later consecutive updates (not including the current update), and the weight of the current update W_{U}. In addition, in some examples, the merging process 800 uses an alpha variable (0≤α≤1). For example, the alpha variable may be the preferable weight for the history in relation to the new update. In various examples, the a hyper-parameter can be used to control the “memory” or the forgetfulness of the model. For example, an alpha of α=1 may result in a weighted average between the history and the new update. As another example, an alpha of α=0 may be used to discard the value of the history and set the total weight on the new update. An alpha of 0<α<1 may thus be used to strike a balance between the two extreme states. In particular, as the value of α is set lower, a higher weight may be given to the new update in relation to the history. In various examples, the value for alpha may be either static or dynamically changed over time.

In various examples, the following formula may be used when calculating the new probability of a value based on two histograms of a feature (i.e., Historyₕᵢₛₜ and Updateₕᵢₛₜ). For example, Eq. 3 may be used to determine the probability of each value in the merged histogram:

$${Merged}_{hist} ( value ) = α \cdot ( \frac{{W}_{H}}{{W}_{H} + {W}_{U}} ) \cdot {History}_{hist} ( value ) + ( 1 - α \cdot ( \frac{{W}_{H}}{{W}_{H} + {W}_{U}} ) ) \cdot {Update}_{hist} ( value ) \qquad Eq . 3$$

where Historyₕᵢₛₜ is the historical histogram and Updateₕᵢₛₜ is the update histogram.

It is to be understood that the block diagram of FIG. 8 is not intended to indicate that the system 800 is to include all of the components shown in FIG. 8. Rather, the system 800 can include fewer or additional components not illustrated in FIG. 8 (e.g., additional client devices, or additional streams of records, histogram-based outlier scores, etc.).

With reference now to FIG. 9, a graph shows an example grouping of interdependent features. The example graph 900 of FIG. 9 includes a set of features 902A, 902B, 902C, 902D, 902F, 902G, 902H, and 902I. The features 902A, 902B, 902C, 902D, 902F, 902G, 902H, and 902I are connected by arrows representing correlation coefficients 904A, 904B, 904C, 904D, 904E, 904F, 904G, 904H, 904I, 904J, 904K, 904L, and 904M. The graph includes groups 906A, 906B, and 906C of interdependent features represented by circles. In particular, group 906A includes features 902A, 902B, 902C, and 902D. Group 906C includes features 902E, 902F, and 902G. Group 906C includes features 902H and 902I.

In the example of FIG. 9, a set of correlation coefficients 904A, 904B, 904C, 904D, 904E, 904F, 904G, 904H, 904I, 904J, 904K, 904L, and 904M are calculated between each pair of the features 902A, 902B, 902C, 902D, 902F, 902G, 902H, and 902I, among other correlation coefficients omitted from FIG. 9. For example, the omitted correlation coefficients may have had calculated values below 0.8. In some examples, a correlation matrix including correlation coefficients 904A, 904B, 904C, 904D, 904E, 904F, 904G, 904H, 904I, 904J, 904K, 904L, and 904M may be generated using some correlation method that holds the correlation coefficient between each pair of features in the dataset. In various examples, the correlation method may be Pearson, Spearman, Kendall, etc. In some examples, each of the correlation coefficients may have a value within the range −1≤x≤1. In some examples, a processor may treat two features as being dependent in response to detecting that their absolute correlation coefficient is greater than a predefined threshold. For example, the threshold used in the example of FIG. 9 may have been 0.79. Redundant features may have a correlation coefficient of 1.

Still referring to FIG. 9, the correlation coefficients 904A, 904B, 904C, 904D, 904E. 904F, 904G, 904H, 904I, 904J, 904K, 904L, and 904M are shown in a graph format in which each feature 902A, 902B, 902C, 902D, 902E, 902F, 902G, 902H, and 902I, is a vertex, and each of the correlation coefficients 904A, 904B, 904C, 904D, 904E, 904F, 904G, 904H, 904I, 904J, 904K, 904L, and 904M between two features is represented by an edge with weight which correspond to the correlation degree. In various examples, using the graph 900, the problem of grouping interdependent features may have been modeled as a graph clustering problem or a clique problem. In particular, the solution indicates sets of related vertices clusters or communities in the graph 900 represented by groups 906A, 906B, and 906C. In various examples, the groups 906A, 906B, and 906C of interdependent features may have been determined by applying a graph clustering algorithm, such as Markov Clustering, ICC, and GMC, or by using a community detection algorithm, such as the Girvan-Newman algorithm, Louvain algorithm, Surprise algorithm, Leiden algorithm, Walktrap algorithm, etc. to the graph 900.

It is to be understood that the block diagram of FIG. 9 is not intended to indicate that the system 900 is to include all of the components shown in FIG. 9. Rather, the system 900 can include fewer or additional components not illustrated in FIG. 9 (e.g., additional client devices, or additional resource servers, etc.).

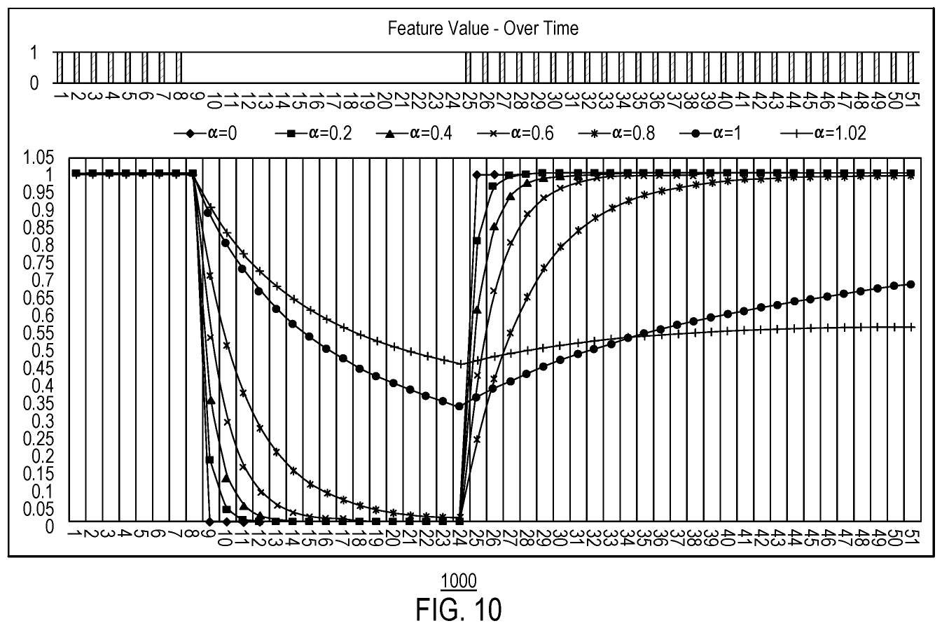

With reference now to FIG. 10, a graph shows the probabilities of a value of a feature over time after consecutive merging processes for a number of different alpha values. The example graph 1000 of FIG. 10 includes a set of 50 feature values of a data stream with values of 0 or 1 over time. A set of lines representing different alpha values 0, 0.2, 0.4, 0.6, 0.8, 1, and 1.02 indicate different weights given to the 0 or 1 value of the 50 feature values received in the data stream to result in an probability between 0 and 1.

FIG. 10 demonstrates the merging process of the probabilities of a value of a feature, over time, using different α values. In this example, the weight of each update is equal to 1. The value of the feature is equal to 0 or 1 as denoted by the upper chart. As can be seen, when using α=1 represented by the line with dots, the probability of the feature value in the 10th update is 0.8, which is exactly the weighted average of eight times that the probability was 1, and two times that the probability was 0. As the α is getting smaller, the model adapts to the latest value faster.

Still referring to FIG. 10, after the RA-HBOS model has been updated, the histogram of each feature reflects all the data that the model has seen so far. The probability of the values in each feature reflects also the prevalence of the feature along the history. A rare feature may therefore have a histogram with probabilities that reflects the feature's lesser prevalence.

It is to be understood that the block diagram of FIG. 10 is not intended to indicate that the system 1000 is to include all of the components shown in FIG. 10. Rather, the system 1000 can include fewer or additional components not illustrated in FIG. 10 (e.g., additional feature values, or additional values of alpha, etc.).

The descriptions of the various embodiments of the present techniques have been presented for purposes of illustration, but are not intended to be exhaustive or limited to the embodiments disclosed. Many modifications and variations will be apparent to those of ordinary skill in the art without departing from the scope and spirit of the described embodiments. The terminology used herein was chosen to best explain the principles of the embodiments, the practical application or technical improvement over technologies found in the marketplace, or to enable others of ordinary skill in the art to understand the embodiments disclosed herein.

What is claimed is:

1. A system, comprising a processor to:
receive a stream of records;
generate an unbiased outlier score for each sample in the stream of records via a trained histogram-based outlier score model, wherein the unbiased outlier score is unbiased for samples including dependent features using feature grouping; and
detect an anomaly in response to detecting that an associated unbiased outlier score of the sample is higher than a predefined threshold.

2. The system of claim 1, wherein the unbiased outlier score is normalized based on a number of feature dimensions of each sample.

3. The system of claim 1, wherein the processor is to use a defined default histogram in response to detecting that a sample in the stream of records includes a new feature.

4. The system of claim 1, wherein the processor is to train the histogram-based outlier score model with the feature grouping, wherein the unbiased outlier score comprises a group-based outlier score.

5. The system of claim 1, wherein the processor is to continuously and adaptively update an outlier score model based on new data received from the stream of records.

6. The system of claim 1, wherein the processor is to update the trained histogram-based outlier score model using a histogram merging.

7. The system of claim 1, wherein the processor is to receive a hyper-parameter, and update the trained histogram-based outlier score model by setting a balance between the weight of a new update and a weight of a previous value of a feature in an outlier score model based on the received hyper-parameter.

8. A computer-implemented method, comprising:
receiving, via a processor, a stream of records;
inputting, via the processor, samples from the stream of records into a trained histogram-based outlier score model to generate an unbiased outlier score for the samples, wherein the unbiased outlier score is unbiased for samples including dependent features using feature grouping; and
detecting, via the processor, an anomaly in response to detecting that an unbiased of a sample is higher than a predefined threshold.

9. The computer-implemented method of claim 8, wherein the feature grouping comprises identifying, via the processor, dependent features in a training set using a generated correlation matrix.

10. The computer-implemented method of claim 8, wherein the feature grouping comprises identifying, via the processor, separate groups of interdependent features in the training set using a graph format.

11. The computer-implemented method of claim 8, wherein the feature grouping comprises setting, via the processor, a histogram-based outlier score for each feature of the stream of records independently, and grouping interdependent features in the stream of records based on identified groups of interdependent features of the training set to generate a single histogram-based outlier score for each group of interdependent features.

12. The computer-implemented method of claim 8, comprising detecting the anomaly using a predefined default histogram representing a low probability in response to detecting a new feature in the stream of records.

13. The computer-implemented method of claim 8, comprising detecting the anomaly using a second predefined default histogram representing a low probability in response to detecting a feature with an associated histogram model is not detected in the stream of records.

14. The computer-implemented method of claim 8, comprising adaptively updating, via the processor, the trained histogram-based outlier score model based on the stream of records wherein adaptively updating the histogram-based outlier score model comprises:
receiving, via the processor, the trained histogram-based outlier score model including a histogram with bins fitted with an initial training set;
generating, via the processor, updated histograms with the same bins based on new data from the stream of records; and
merging, via the processor, the updated histograms to generate a merged histogram for an updated model.

15. A computer program product for detecting anomalies in data streams, the computer program product comprising a computer-readable storage medium having program code embodied therewith, the program code executable by a processor to cause the processor to:
receive a stream of records;
generate an unbiased outlier score for each sample in the stream of records via a trained histogram-based outlier score model, wherein the unbiased outlier score is unbiased for samples including dependent features using feature grouping; and
detect an anomaly in response to detecting that an associated unbiased outlier score of the sample is higher than a predefined threshold.

16. The computer program product of claim 15, further comprising program code executable by the processor to identify dependent features in a training set using a generated correlation matrix.

17. The computer program product of claim 15, further comprising program code executable by the processor to identify separate groups of interdependent features in the training set using a graph format.

18. The computer program product of claim 15, further comprising program code executable by the processor to set a histogram-based outlier score for each feature of the stream of records independently, and group interdependent features in the stream of records based on identified groups of interdependent features of the training set to generate a single histogram-based outlier score for each group of interdependent features.

19. The computer program product of claim 15, further comprising program code executable by the processor to normalize the unbiased outlier score based on a number of feature dimensions of each sample.

20. The computer program product of claim 15, further comprising program code executable by the processor to:
receive the trained histogram-based outlier score model including a histogram with bins fitted with an initial training set;
generate updated histograms with the same bins based on new data from the stream of records; and
merge the updated histograms to generate a merged histogram for an updated model.
